(19) United States
(12) Patent Application Publication
(10) Pub. No.: US 2026/0339639 A1
(43) Pub. Date: Oct. 29, 2026

(54) INSTALLATION STATUS VERIFICATION IN A MULTISERVICE FRAMEWORK

(71) Applicant: Dell Products L.P., Round Rock, TX (US)

(72) Inventors: Daniel L. HAMLIN, Round Rock, TX (US); Danilo O. TAN, Austin, TX (US); Suraj M. VARMA, Portland, OR (US)

(73) Assignee: Dell Products L.P., Round Rock, TX (US)

(21) Appl. No.: 19/190,233

(22) Filed: Apr. 25, 2025

(51) Int. Cl. G06F 8/61

(52) U.S. Cl. CPC G06F 8/61

(57) ABSTRACT

Disclosed methods and systems provision an information handling system with an installation status verification (ISV) service configured to perform ISV operations. The ISV operations monitor the system to detect new device driver installations and, responsive to detecting a new device driver installation, determine a companion software status indicating whether companion software associated with the driver has been successfully installed. If the companion software status is not indicative of successful installation of the companion software, one or one or actions may be taken in response. Representative actions include notifying an end user of the companion software status and explicitly installing the companion software.

### TECHNICAL FIELD

The present disclosure is in the field of information handling systems and, more specifically, managing installation and configuration of such systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems, including, desktop, laptop, and all-in-one systems, collectively referred to herein as client systems, may be distributed by original equipment manufacturers (OEMs) as platforms that implement an end user environment that supports, in addition to the hardware and operating system, additional functionality including apps, services, functions, and/or drivers developed by the OEM and/or hardware and software vendors. In at least some instances, however, platform-supported functionality is not being installed onto end user systems. Un-installed functionality can equate to lost capabilities and/or reduced performance that can negatively impact the end user experience.

### SUMMARY

Issues arising from the myriad of disparate sources, protocols, and procedures associated with platform capabilities are addressed by methods and systems disclosed herein. In one aspect of disclosed subject matter, systems and methods are configured to provide platform support operations for information handling systems including, without limitation, business client systems, e.g., desktop, laptop, and all-in-one devices. The platform support operations may include accessing a platform capability manifest (PCM) containing information indicative of a defined combination of software services, functions, and configuration options collectively referred to herein as capabilities. Software services that may be included in the platform capabilities may include software services developed and maintained by multiple developers, vendors, or the like. As examples, software services within the platform capabilities may include one or more OEM software services and one or more operating system (OS) software services.

Platform support operations may further include identifying, from the PCM, platform capability resources required to implement the platform capabilities. In at least some implementations, determining the platform capability resources includes identifying a file repository for each of the software services. Such repositories may include any one or more of: a cloud-resident OEM support repository and a cloud resident OS update repository and one or more local repositories.

A plurality of varied installation routines may then be invoked to install and register the platform capabilities and thereby provision the system with foundational capabilities. Examples of installation routines may include any one or more of: service registration routines to register a software service directly into system services, a plug and play (PnP) installation routine for installing software services for one or more ACPI devices, an INF extension installation routine for extending functions of existing ACPI devices, virtual ACPI device routines to create, register, and install drivers for virtual ACPI devices, and firmware (FW) volume installation routine for creating and populating runtime FW modules.

Platform support operations may further include performing initial configuration operations for one or more of the software services. In such cases, the initial configuration settings may be determined based on platform settings information included in the PCM.

In at least some embodiments, the PCM comprises an aggregation of two or more manifest components. Manifest components may include, as examples, a cloud-based OEM support manifest and one or more local manifests residing on the system. The local manifests may include a basic input/output system (BIOS) manifest resident in a BIOS store of the information handling system and an embedded controller (EC) manifest resident in an EC store of the information handling system.

A second aspect of the multiservice framework, disclosed methods and systems enable and support PCM creation and support operations to discover existing capabilities running on a host, including OS capabilities running in a host OS and firmware capabilities running in host firmware, and obtaining a capability management policy for the host. Obtaining the capabilities management policy may include retrieving the capabilities management policy from a cloud-based service provided by the OS vendor, e.g., Windows Update cloud for Windows OS hosts, the OEM, e.g., Dell Command Update for Dell hosts, silicon vendor, e.g., Intel Driver & Support Assist for Intel processors, hardware vendor, BIOS developer, or the like.

The discovering of existing capabilities of the host may include discovering OS capabilities with an OS software service, discovering firmware capabilities with a firmware software service, and so forth. The platform capabilities for the host may then be identified, listed, or otherwise determined based, at least in part, on the existing capabilities and the capability management policy. A PCM may then be created based on the identified capabilities. The PCM may be stored as a distributed resource including two or more PCM components including one or more local PCM components and one or more cloud resident PCM components. Some or all of the PCM components may be associated with corresponding file repositories.

In at least some embodiments, the PCM creation and support operations may additionally perform configuration operations to configure the host with capabilities in accordance with the PCM. In these embodiments, the configuration operations may, for example, resolve one or more differences between existing capabilities and the full set of platform capabilities.

For business client systems and other hosts that include a BIOS chip and an EC, the local PCM components may include a BIOS PCM component stored in the BIOS and an EC PCM component stored in the EC.

A third aspect of the multiservice framework enables a streamlined installation and configuration of software services and/or other resources supporting the platform capabilities. In this aspect, disclosed methods and systems obtain the PCM, which indicates the platform capabilities for an information handling system, and identify, based on the platform capabilities indicated in the PCM, a plurality of installations files required to implement platform capabilities and their corresponding repositories. These installation files are then retrieved from the applicable repositories.

A multiservice installation payload encompassing the plurality of installation files may be generated before invoking a multiservice installation service to install platform capabilities in accordance with the installation payload. Obtaining the PCM may include obtaining two or more PCM components including at least one local PCM component associated with at least one local repository and at least one cloud based PCM component associated with at least one cloud repository, e.g., Windows Update cloud service for Windows OS capabilities, a Dell Update cloud service for Dell-added OS capabilities, etc.

In at least some embodiments, identifying the installation files includes providing a prioritized list of the installation files. In at least some embodiments, prioritization may include determining file attributes for the installation files and prioritizing the files based, at least in part, on one or more of the file attributes.

In a fourth aspect, disclosed methods and systems for managing an information handling system respond to detecting installations of device drivers by verifying or otherwise confirming that companion software associated with the driver has been successfully installed and taking action if the companion software has not been successfully installed. When a new device driver is installed, conventional OS native installers may install companion software if the companion software is available. However, at least some native installation resources and protocols may complete and exit the driver installation regardless of the installation status of companion software. If the companion software is not available or the companion software install fails for one or more other reasons, the user may have no easy way of knowing the software companion did not install.

Addressing such issues, disclosed methods and systems may provision the system with an installation status verification (ISV) service configured to perform ISV operations. In at least some embodiments, the ISV operations monitor the system to detect new device driver installations and, in response to detecting installation of a new device driver, determine a companion software status. For purposes of this disclosure, the term “companion software status” refers to an indication of whether companion software associated with a new device driver has been successfully installed. If the companion software status is not indicative of successful installation of the companion software, one or more actions may be taken in response. Representative actions include notifying an end user of the companion software status and explicitly invoking an install service to install the companion software.

The ISV service may be implemented as an OS-level service that runs in a background of the host OS. In some embodiments, the new device driver is a plug and play (PnP) device driver and the ISV service executes in conjunction with an OS-native installer including, as a representative example, a Windows Software Installer.

In at least some embodiments, determining the companion software status includes determining the companion software status based, at least in part, on various indicators including, as representative examples, any one or more of the following: changes in a driver store of the information handling system, changes in a registry path of the information handling system, indicators of companion, software (installer, command line switches, etc.) parsed from an information (INF) file associated with the new device driver, parsing companion software installation files indicators of a product identifier parsed from companion software install files, e.g., EXE files and Microsoft Software Installer (MSI) files, a completion status of device driver installation, and confirmation of a product identifier (ID) registered with the host OS.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an information handling system platform enabled to implement multiservice distribution features in accordance with disclosed subject matter;

FIG. 2 illustrates an exemplary implementation of core software services for multiservice distribution;

FIG. 3 illustrates a core multiservice distribution method;

FIG. 4 illustrates an exemplary implementation of software services for implementing, maintaining, and otherwise providing a PCM;

FIG. 5 illustrates a flow diagram of an exemplary method for creating and using a PCM;

FIG. 6 illustrates portions of an exemplary PCM;

FIG. 7 illustrates an exemplary implementation of software services enabling multiservice installation;

FIG. 8 is a flow diagram illustration of an exemplary multiservice installation method;

FIG. 9 illustrates an exemplary implementation of an information handling system including an ISV service;

FIG. 10 illustrates a flow diagram depiction of a representative ISV method; and

FIG. 11 illustrates an exemplary information handling system suitable for use in conjunction with subject matter disclosed in the preceding figures and the accompanying detailed description below.

### DETAILED DESCRIPTION

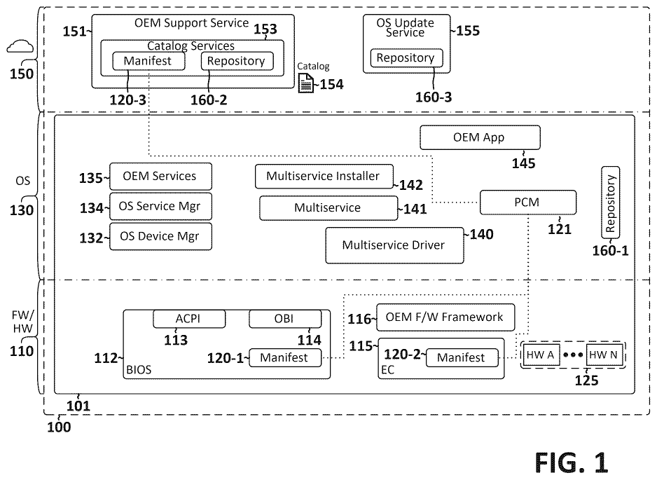

Exemplary embodiments and their advantages are best understood by reference to FIGS. 1-11, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 illustrates an exemplary platform 100 for a host information handling system 101, alternatively referred to herein simply as host 101, including a multiservice driver 140 enabling a software service referred to herein as multiservice 141. Before disclosing features of multiservice 141, an overview of platform 100 is presented.

As depicted in FIG. 1, platform 100 encompasses resources within a hardware/firmware (HW/FW) layer 110 and an OS layer 130 of host 101 as well as cloud-based resources within a cloud layer 150. The HW/FW layer 110 illustrated in FIG. 1 includes a BIOS 112, an EC 115, and additional hardware devices 125 including one or more general purpose processors, graphics processing units, memory devices, persistent storage devices, chipset devices, network interface devices, display devices, human interface devices, etc.

BIOS 112 may encompass a dedicated nonvolatile storage device as well as BIOS code stored therein. The BIOS 112 of FIG. 1 is depicted as including an ACPI service 113 and an OEM service referred to herein as OEM BIOS interface (OBI) 114. ACPI service 113 is enabled to support ACPI-compliant resources including power delivery resources, thermal management devices, storage controllers, and other devices that support manageable power states. OEM BIOS interface 114 may include OEM-developed BIOS security and manageability features. An example of an OEM BIOS interface is the Dell Access Controller Interface (DACI) from Dell Technologies. The HW/FW layer 110 of FIG. 1 additionally incudes an OEM firmware framework 116. In at least some embodiments, OEM firmware framework 116 may enable, as an example, a support network for over-the-air firmware updates.

The OS layer 130 depicted in FIG. 1 includes an OS device manager 132, an OS service manager 134, OEM services 135, and a value-added OEM app 145. OS service manager 134 may provide file management services, memory management services, I/O device services, program execution services, and so forth. OS device manager 132 may enable an OS utility for identifying, viewing, configuring, and otherwise managing a system's hardware devices. OEM services 135 may include OEM developed functionality for supporting OEM systems. Examples of OEM services 135 include Dell Command Configure (DCC) and Dell Command Update from Dell Technologies. Such services may facilitate management of OEM system software updates and configuring BIOS settings on OEM systems.

The cloud layer 150 of FIG. 1 includes an OS update service 155 and an OEM update service 151. OS update service 155 may correspond to a software service from Microsoft or another OS vendor that enables automated downloads and installations of OS updates. OEM update service 151 may enable users of OEM systems to create and manage customized updates via one or more catalogs 154. An enterprise might use custom update catalogs, for example, to facilitate driver, firmware, BIOS, and application updates. An example of such a catalog-based service is the Dell Command Update Cloud from Dell Technologies.

FIG. 1 further illustrates software resources used primarily in the context of the multiservice framework disclosed herein. Multiservice components depicted in FIG. 1 include multiservice driver 140, a corresponding software service referred to herein as multiservice 141, and a multiservice installer 142. These multiservice components may access and interact with a PCM 121 derived from one or more manifest components 120 and one or more software repositories 160.

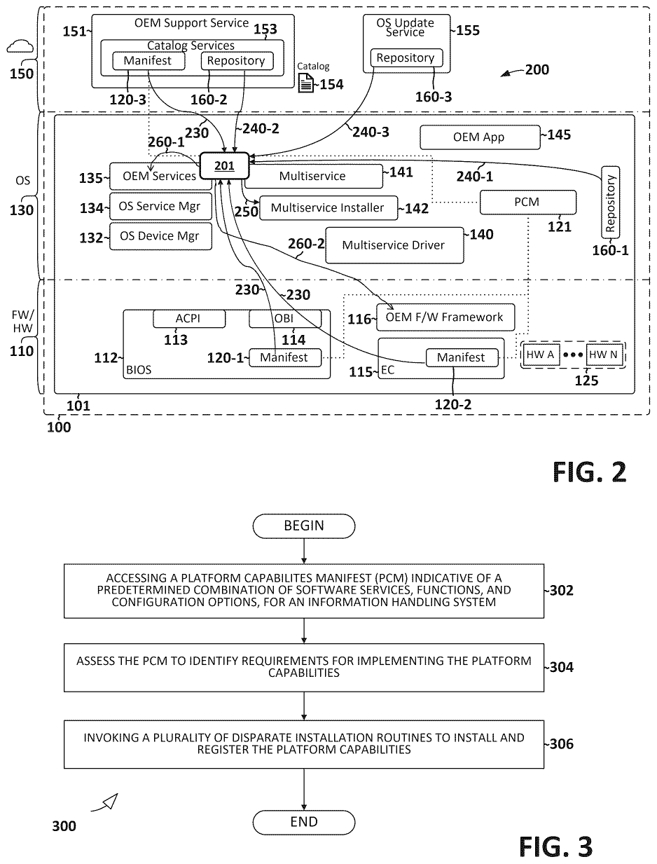

FIG. 2 illustrates an exemplary implementation 200 of a core software service 201 of multiservice 141. As depicted in FIG. 2, the core software service 201 runs within OS layer 130 and is enabled to ensure that platform-supported capabilities indicated in PCM 121 are continuously available to the end user.

The core software service 201 depicted in FIG. 2 retrieves (230) platform capability information from multiple PCM components 120 to create PCM 121. The PCM components 120 illustrated in the exemplary software services 200 employ two local PCM components including BIOS PCM component 120-1 and EC PCM component 120-2, and a cloud-based PCM component 120-3. Other implementations may employ more or fewer local PCM components and more and/or different cloud-based PCM components.

Core software service 201 may analyze or otherwise process the capability information in PCM 121 to discover, extract, or otherwise determine files and/or other resources required to enable the platform capabilities and a file repository corresponding to each such file. Such resources may include, as non-limiting examples, source code and/or binary code for one or more new or updated capabilities and installation routines for some or all of the capabilities. Multiservice 141 may then retrieve (240) the files and/or other resources from their corresponding repositories 160. The software services 200 depicted in FIG. 2 utilize three repositories 160-1, 160-2, and 160-3 and perform three corresponding file retrievals 240-1, 240-2, and 240-3. Other implementations (not depicted) may include more, fewer, and/or different file repositories 160 and more, fewer, and/or different retrievals 240 than those depicted in FIG. 2.

In at least some embodiments, core software service 201 may invoke (250) multiservice installer 142 to execute a single installation sequence to install (260) resources enabling the platform capabilities. For the sake of clarity and brevity, the installation 260 depicted in FIG. 2 emphasizes the installation of OEM capabilities including the installation 260-1 of one or more OS level software services via OEM services 135 and the installation 260-2 of one or more OEM firmware features via OEM firmware framework 116. Although not expressly depicted in FIG. 2, additional and/or different installations 260 may be supported including, as non-limiting examples, installations pertaining to OS updates and features, installations of updates or features for an OEM value added app 145, and installations of features, updates, etc. specific to the manufacturers and/or vendors of hardware components.

FIG. 3 is a flow diagram illustration of a method 300 including core operations of multiservice 141 for enabling and maintaining platform supported capabilities on end user systems such as host 101 (FIG. 1). As depicted in FIG. 3, the illustrated method 300 provides platform support by creating, retrieving, obtaining, or otherwise accessing (302) a PCM, e.g., PCM 121, listing or otherwise containing information indicative of platform capabilities, including a predetermined combination of software services, functions, and configuration options for the host 101. Platform capabilities may encompass one or more OEM software services as well as one or more OS software services. The illustrated method may then identify or otherwise determine (304) from the PCM, platform capability resources required to implement the platform capabilities, and invoke (306) a plurality of distinct and varied installation routines to install and register platform capabilities. In at least some embodiments, initial configuration operations may be performed for one or more of the software services. In such cases, initial configurations may be based on platform settings information included in the PCM.

The PCM may be aggregated from a plurality of manifest components including a cloud-based OEM support manifest and one or more resident manifests. The resident manifests may include, as non-limiting examples, a BIOS manifest component and/or an EC manifest component.

Determining the platform capability resources may include identifying a file repository for each of the software services. The one or more file repositories may include: a cloud-resident OEM support repository, a cloud resident OS update repository, and a local repository residing within the host OS.

Consistent with multiservice features, the plurality of varied installation routines may include, as non-limiting examples, a service registration routine to register software services directly into system services, a PnP installation routine for installing software services supporting one or more ACPI devices, and an INF extension installation routine for processing INF files extending functions of existing ACPI devices. Additionally, service registration routines may encompass virtual ACPI device routines for creating, registering, and installing drivers for a virtual ACPI device, and firmware volume installation routines for creating and populating runtime FW modules.

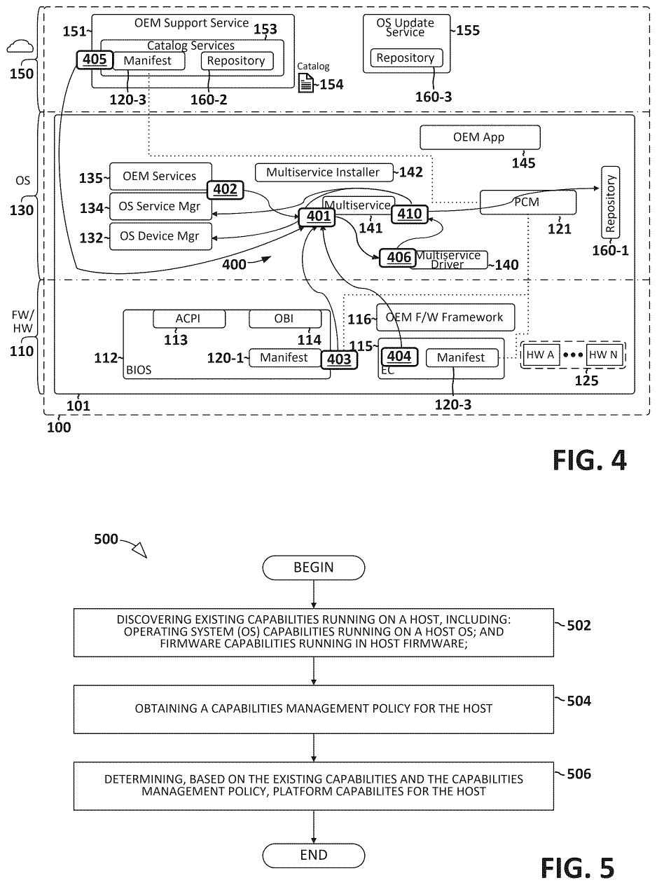

Turning now to FIG. 4, an exemplary implementation of manifest software services 400 for implementing, maintaining, and otherwise providing PCM 121 is depicted. The illustrated manifest software services 400, running in host OS 130, are responsible for collecting and enumerating system capabilities and configuration options based on multiple inputs including, without limitation, hardware detected components, firmware enumerated and managed configuration settings, OS resident settings, and cloud service provisioning. Manifest software services 400 may additionally manage prohibited capabilities, i.e., capabilities that the platform is prohibited from enumerating, to ensure that prohibited capabilities are not installed or enabled.

The manifest software services 400 depicted in FIG. 4 include a first manifest software service 401 running in host OS 130, which is enabled to collect and consolidate existing capabilities information indicative of capabilities, policies, and configuration settings, currently enabled on the host. In at least some embodiments, first OS service 401 receives existing capabilities information from multiple supporting software services including one or more supporting software services depicted in FIG. 4 including a second manifest software service 402, manifest firmware services 403 and 404, and manifest cloud service 405. Second manifest software service 402 is enabled to collect existing capabilities and configuration policies from one or more OS level components including, in the depicted implementation, OEM services 135 and/or OS service manager 134. Firmware manifest services 403 and 404, which are depicted running in HW/FW layer 110 of host 101, may be enabled to collect or otherwise determine existing firmware capabilities and configuration policies from one or more devices including, in the depicted implementation, BIOS 112, EC 115, and/or other firmware-static devices. Firmware manifest services 403 and 404 may then provide a list of existing firmware capabilities to first manifest software service 401. As depicted in FIG. 4, cloud manifest software service 405, running off-host, may be responsible for providing policy management information, indicative of capabilities and configurations to be executed by host 101. Additionally, a third manifest software service 406 may be responsible for concatenating or otherwise consolidating all capabilities and policy settings provided to first manifest software service 401 into a single manifest file, PCM 121.

A fourth manifest software service 410 is enabled to provision host 101 with capabilities and configuration settings in accordance with PCM 121 as provided by third manifest service 406. In at least some embodiments, fourth manifest software service 410 may be enabled to determine configuration policy priorities and perform arbitration and/or remediation to resolve any policy conflicts. Fourth manifest software service 410 may also be responsible for storing implemented policy based on determination of system path to file storage.

FIG. 5 is a flow diagram illustration of an exemplary PCM creation method 500. The illustrated method begins by discovering (502) existing capabilities running on a host. The existing capabilities may include existing OS capabilities running on a host OS and existing firmware capabilities running in host firmware. The illustrated method 500 may additionally include obtaining (504) a capabilities management policy for the host and determining (506), based on the existing capabilities and the capabilities management policy, platform capabilities for the host. Upon determining the platform capabilities, method 500 may further include creating, based on the platform capabilities, a PCM suitable for use in disclosed multiservice functionality. In at least some embodiments, method 500 may further include performing configuration operations to configure the host with capabilities in accordance with the PCM. In at least some of these embodiments, configuration operations may resolve one or more differences between the existing capabilities and the platform capabilities.

Discovering the existing capabilities of the host may include discovering, with an OS capabilities software service, the OS capabilities, and discovering, with a firmware capabilities software service, the firmware capabilities. Obtaining the capabilities management policy may include retrieving the capabilities management policy from a cloud-based service such as a cloud-based OEM support service for OEM host systems, i.e., host systems manufactured and/or distributed by an OEM.

In some implementations, the PCM may be stored as two or more PCM components in two or more corresponding file repositories. In some embodiments, the two or more PCM components include at least one of: one or more local PCM components and one or more cloud based PCM components.

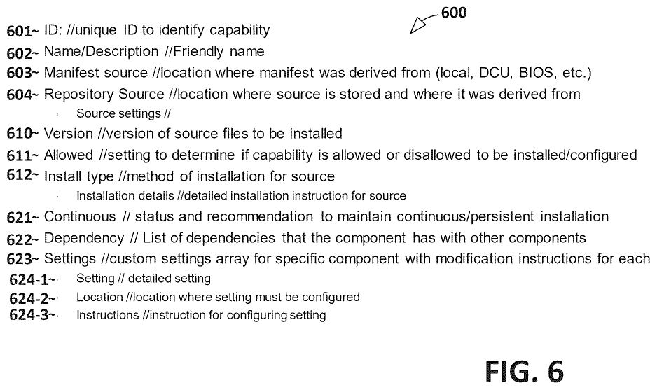

FIG. 6 illustrates a portion 600 of exemplary PCM 121, wherein the illustrated portion corresponds to a particular capability. A complete PCM may include a concatenated list of multiple platform capabilities.

The portion of PCM 121 illustrated in FIG. 6 includes an identifier (ID) 601 to identify the applicable capability, a name/description 602 to provide a user friendly name, a manifest source 603 indicating a network location of the applicable manifest component, and a repository source 604 indicating a location wherein the source is stored and where it was derived from.

The portion of PCM 121 depicted in FIG. 6 may further include version information 610 indicating version information for source files to be installed, an allowed indicator 611 for a setting to indicate whether installation of the applicable capability is allowed or disallowed, and an install type indicator 612 indicating a method for installing the source file include any detailed installation instructions for a particular source.

The portion of PCM 121 depicted in FIG. 6 may still additionally include continuous information 621 indicating a status and/or recommendation to maintain continuous/persistent installation, dependency information 622 indicating any dependencies between the capability and other components, and settings information 623 providing, in at least some embodiments, detailed settings values and/or information 624-1, location information 624-2 indicating locations where the setting may be configured, and any required instructions 624-3 for configurating the setting.

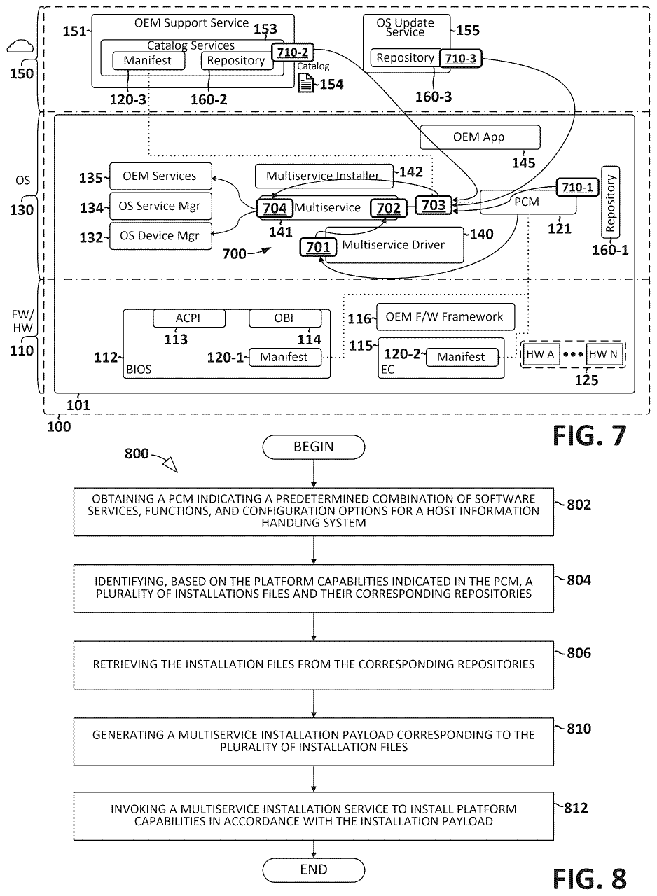

FIG. 7 illustrates an implementation of installation software services 700, running in host OS 130, to obtain and prioritize capability installation packages to implement system capabilities in accordance with configuration policies including, but not strictly limited to IT-managed configuration policies.

In the implementation of installation software services 700, a first installation software service 701 retrieves platform capabilities information from PCM 121, generated in accordance with subject matter depicted in FIGS. 4, 5, and 6 and the accompanying text, and provides the information to second installation software 702. Second installation service 702 may process PCM 121 to identify required resources information, including information indicative of one or more installation files required to implement the platform capabilities, and pass the required resources information to third installation software service 703. Third installation software service 703 may retrieve required resources, including one or more installation files from one or more file repositories 160, including OS repository 160-1, OEM cloud repository 160-2, and OS update repository 160-3 based on the required resource information received from second installation software service 702. Third installation software service 703 may then package or otherwise process the required resources, including the one or more installation files, as an installation payload and provide the payload to fourth installation software service 704. Fourth installation software service 704 may then execute one or more installation routines corresponding to the installations indicated in the installation files retrieved by third software service 703.

FIG. 7 additionally illustrates repository services 710 including OS repository services 710-1 running on host agents and remote repository services 710-2 and 710-3 running on remote agents. Repository services 710 may be responsible for collecting attributes of requested files and packages identified in the payload delivered by third installation software service 703 and returning a prioritized list of files to fourth installation software service 704 for further installation.

FIG. 8 is a flow diagram illustration of an exemplary multiservice installation method 800. The method 800 depicted in FIG. 8 includes obtaining (802) a PCM indicating a predetermined combination of software services, functions, and configuration options for host 101 and identifying (804), based on the platform capabilities indicated in the PCM, a plurality of installation files and their corresponding file repositories, and retrieving (806) the installation files from the corresponding repositories. The illustrated method 800 additionally includes generating (810) a multiservice installation payload corresponding to the plurality of installation files and invoking (812) a multiservice installation service to install platform capabilities in accordance with the installation payload.

In at least some embodiments, obtaining the PCM may comprise obtaining two or more PCM components including one or more local PCM component(s) and one or more remote or cloud based PCM components. In at least some such embodiments, local PCM components may be associated with local file repositories and remote PCM components may be associated with cloud-based file repositories. Cloud-based file repositories may include an OEM support repository for OEM-specific services and functionality and an OS update repository.

Installation files may be prioritized, in at least some embodiments, based on one or more file attributes. Such prioritizations may include simple prioritization based on file size, date, etc., and more complex prioritizations including prioritization based on one or more dependencies involving one or more other files.

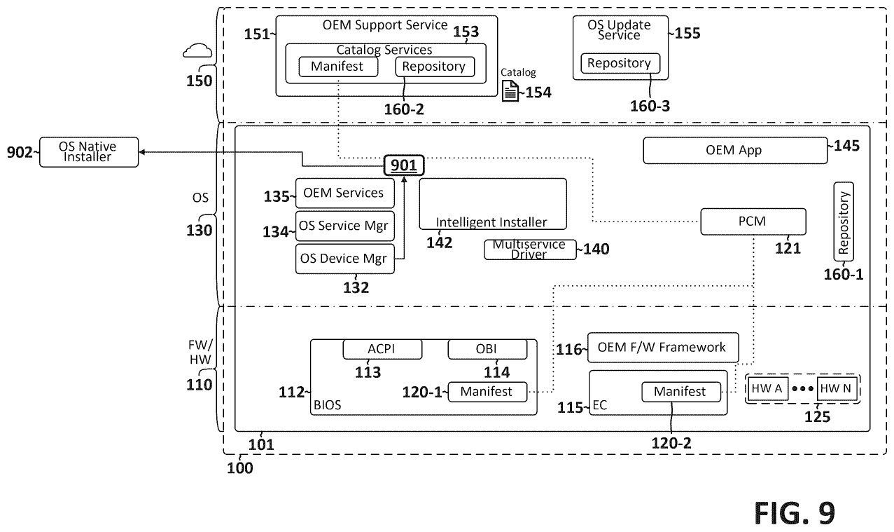

Turning now to FIG. 9, a representative implementation of an information handling system provisioned with a software service, referred to herein as ISV service 901, is illustrated. For purposes of this description, information handling system 100 may be referred to as the host or the host system and OS 130 may be referred to as the host OS. In at least some embodiments, ISV service 901 is provisioned with functionality for monitoring and assisting companion software installations associated with new device driver installations. Because the native OS installer 902 may initiate installation of companion without subsequently confirming a successful installation, ISV service 901 is configured to determine the companion software status independently.

The ISV service 901 depicted in FIG. 9 is an OS-level service, running in a background of the host OS, that monitors an OS-native installer 902 to detect installations of device drivers. For embodiments of the host system featuring a Windows family OS from Microsoft, the OS-native installer 902 may correspond to a Windows Installer. In at least some instances, installation of the new device driver is triggered automatically when a PnP-compliant hardware component is installed on a system with PnP support.

ISV service 901 may respond to detecting an installation of a new device driver by determining a companion software status, i.e., determining whether companion software for the applicable device driver has been successfully installed. ISV service 901 may determine the companion software status by performing any one or more of various operations or functions that may signify successful companion software installation. Such operations and functions may include, without limitation, monitoring changes in the host driver store or registry path, parsing one or more INF files associated with the applicable driver for companion software information such as the identity and/or location of an installer or installation package, command line switches, etc., monitoring a completion status of the driver installation, parsing companion software installation files, e.g., MSI and/or EXE files, for a product ID and verifying the companion software product ID is registered with the host OS.

If ISV service 901 is unable to verify successful installation of companion software, ISV service 901 may perform one or more responsive actions including, generating a companion software error, interrupt, or exception, notifying an end user and/or ITDM of the companion software error, and/or initiating an explicit installation of the companion software.

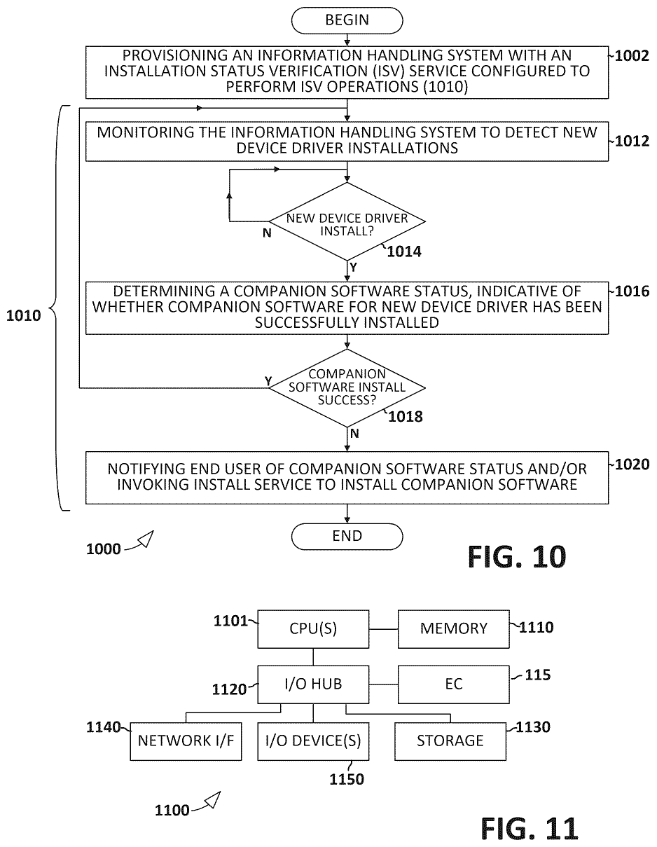

Referring now to FIG. 10, a flow diagram depiction of a representative ISV method 1000 for verifying installation status of companion software following a new device driver installation is presented. The ISV method 1000 of FIG. 10 includes provisioning (1002) an information handling system with an ISV service configured to perform ISV operations (1010). The ISV operations 1010 depicted in FIG. 10 include monitoring (1012) the information handling system to detect new device driver installations. Whenever a new device driver installation is detected (1014), a companion software status is determined (1016). In at least some embodiments, the companion software status is indicative of whether companion software associated with the new device driver has been successfully installed. Responsive to determining (1018) a companion software status not indicative of a successful companion software installation, one or more actions 1020 are performed. The actions 1020 depicted in FIG. 10 include notifying an end user of the companion software status and performing an explicit installation of the companion software by invoking an install service.

Referring now to FIG. 11, any one or more of the elements illustrated in FIG. 1 through FIG. 10 may be implemented as or within an information handling system exemplified by the information handling system 1100 illustrated in FIG. 11. The illustrated information handling system includes one or more general purpose processors or central processing units (CPUs) 1101 communicatively coupled to a memory resource 1110 and to an input/output hub 1120 to which various I/O resources and/or components are communicatively coupled. The I/O resources explicitly depicted in FIG. 11 include a network interface 1140, commonly referred to as a NIC (network interface card), storage resources 1130, and additional I/O devices, components, or resources 1150 including as non-limiting examples, keyboards, mice, displays, printers, speakers, microphones, etc. The illustrated information handling system 1100 includes an embedded controller EC 115 may provide or support various system management functions and, in at least some implementations, keyboard controller functions. Exemplary system management function that may be supported by EC 115 include thermal management functions supported by pulse width modulation (PWM) interfaces suitable for controlling system fans, power monitoring functions support by an analog-to-digital (ADC) signal that can be used to monitor voltages and, in conjunction with sense resistor, current consumption per power rail. This information could be used to, among other things, monitor battery charging or inform the user or administrator of potentially problematic power supply conditions. EC 115 may support battery management features to control charging of the battery in addition to switching between the battery and AC adapter as the active power source changes or monitoring the various battery status metrics such as temperature, charge level and overall health. EC 115 may support an Advanced Configuration and Power Interface (ACPI) compliant OS by providing status and notifications regarding power management events and by generating wake events to bring the system out of low power states.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method for managing an information handling service, the method comprising:
provisioning the information handling system with an installation status verification (ISV) service, wherein the ISV service is configured to perform ISV operations including:
monitoring the information handling system to detect new device driver installations;
responsive to detecting an installation of a new device driver, determining a companion software status, wherein the companion software status is indicative of whether companion software associated with the new device driver has been successfully installed;
responsive to determining a companion software status not indicative of successful installation of the companion software, performing one or one or actions selected from:
notifying an end user of the companion software status; and
invoking an install service to install the companion software.

2. The method of claim 1, wherein the ISV service runs in a background of an OS for the information handling system.

3. The method of claim 1, wherein the new device driver comprises a plug and play (PnP) driver.

4. The method of claim 1, wherein invoking the install service comprises invoking an OS-native installer.

5. The method of claim 1, wherein invoking the install servicer comprises invoking an installer service of a multiservice framework provisioned on the information handling system.

6. The method of claim 1, wherein determining the companion software status includes determining the companion software status based, at least in part, on any one or more of:
changes in a driver store of the information handling system;
changes in a registry path of the information handling system;
parsing an information (INF) file associated with the new device driver for an indication of companion software (installer, command line switches, etc.);
parsing companion software installation files for a product identifier;
checking driver install completion; and
verifying companion software product ID is registered with the operating system.

7. An information handling system, comprising:
a central processing unit (CPU); and
a system memory, accessible to the CPU, including processor-executable instructions for an installation status verification (ISV) service that, when executed by the CPU, cause the system to perform ISV operations including:
monitoring the information handling system to detect new device driver installations;
responsive to detecting an installation of a new device driver, determining a companion software status, wherein the companion software status is indicative of whether companion software associated with the new device driver has been successfully installed;
responsive to determining a companion software status not indicative of successful installation of the companion software, performing one or one or actions selected from:
notifying an end user of the companion software status; and
invoking an install service to install the companion software.

8. The information handling system of claim 7, wherein the ISV service runs in a background of an OS for the information handling system.

9. The information handling system of claim 7, wherein the new device driver comprises a plug and play (PnP) driver.

10. The information handling system of claim 7, wherein invoking the install service comprises invoking an OS-native installer.

11. The information handling system of claim 7, wherein invoking the install servicer comprises invoking an installer service of a multiservice framework provisioned on the information handling system.

12. The information handling system of claim 7, wherein determining the companion software status includes determining the companion software status based, at least in part, on any one or more of:
changes in a driver store of the information handling system;
changes in a registry path of the information handling system;
parsing an information (INF) file associated with the new device driver for an indication of companion software (installer, command line switches, etc.);
parsing companion software installation files for a product identifier;
checking driver install completion; and
verifying companion software product ID is registered with the operating system.
